(19) United States
(12) Patent Application Publication
(10) Pub. No.: US 2021/0330056 A1
(43) Pub. Date: Oct. 28, 2021

(54) COSMETIC CONTAINER WITH DISCHARGE STRUCTURE FOR MIXING HETEROGENEOUS CONTENTS

(71) Applicant: PUM-TECH KOREA CO., LTD, Incheon (KR)

(72) Inventor: Do Hoon LEE, Incheon (KR)

(21) Appl. No.: 17/218,061

(22) Filed: Mar. 30, 2021

(30) Foreign Application Priority Data
Apr. 28, 2020 (KR) 10-2020-0051370

(51) Int. Cl. A45D 34/04

(52) U.S. Cl. CPC A45D 34/04; A45D 2200/058

(57) ABSTRACT

A cosmetic container with a discharge structure for mixing heterogeneous contents according to one embodiment of one aspect of the present disclosure includes: a container body in which heterogeneous contents are stored; a discharging device for discharging the heterogeneous contents stored in the container body; and a button configured to operate the discharging device and formed with a discharge passage and a discharge port, wherein a mixing shaft member and a mixing cap member are formed in the discharge passage and the discharge port, so that the heterogeneous contents are mixed with each other.

### CROSS-REFERENCE TO RELATED APPLICATIONS

This application claims the priority of Korean Patent Application No. 10-2020-0051370 filed on Apr. 28, 2020, in the Korean Intellectual Property Office, the disclosure of which is incorporated herein by reference.

### BACKGROUND OF THE INVENTION

### 1. Field of the Invention

One aspect of the present disclosure relates to a cosmetic container, and more particularly, to a cosmetic container with a discharge structure for mixing heterogeneous contents, in which a mixing shaft member and a mixing cap member are provided in a discharge passage of a button, so that the heterogeneous contents are efficiently mixed while continuously passing through the mixing shaft member and the mixing cap member and discharged to the outside.

### 2. Description of the Related Art

In general, there are many cases in which two or more different contents are mixed and used in order to double the efficacy or effect on cosmetics or pharmaceuticals contained in a container.

However, when the contents to be mixed for use as described above are mixed from the beginning, stored together in a single container, and then distributed or stored, a chemical reaction occurs inside the container and the contents are solidified or precipitated, thereby resulting in poor discharge, or the contents are discolored or deteriorated.

Accordingly, in the related art, a user stores the contents of different ingredients in different containers, separately discharges the contents, and directly mixes and uses the contents, or the user stores the different contents in separated different containers, opens openings of the two containers, and mixes and uses the contents in an additional container. The above approaches may cause problem such as the inconvenience of user required to directly mix and use the contents stored in the separate containers, the risk of loss, and the poor portability.

Accordingly, recently, a foreign liquid material mixing container has been developed such that the heterogeneous contents are isolated and stored in one container to simultaneously discharge, mix and use the heterogeneous contents by the user's operation if necessary.

In the related art, Korean Patent Registration No. 10-1923306 discloses a mixing container for heterogeneous substances. According to the above related art, an inner container is inserted and mounted to an outer container, each of the container is equipped with one of pump sets, and different cosmetics contents are stored in the outer container and the inner container, respectively, so that the different kinds of cosmetic contents can be simultaneously discharged, mixed, and used with one pumping.

However, according to the above related art, since different types of contents are merely discharged to the outside through a discharge port at the same time, and the different contents are incompletely mixed, the efficacy or effect cannot be properly utilized.

In order to solve the above problem, Korean Patent Publication No. 10-2017-0012917 discloses a vessel having mixed two-type materials. According to the above related art, a first contents moving tube and a second contents moving tube are connected in the same direction from the inside of a button part, in which a tube diameter of the second content moving tube is formed larger than that of the first content moving tube to increase a moving speed in the process of moving first contents to the second contents moving tube, and the first and second contents are primarily mixed, and secondarily mixed while passing through a mixing structure inside a nozzle unit, so that the different kinds of contents can be efficiently mixed.

However, the above related art is configured such that the first and second contents are mixed with each other by a content mixing protrusion formed in the nozzle unit in the process that the first and second contents pass through the mixing structure of the nozzle unit, that is, such that different contents simply hit a predetermined obstacle repeatedly and entangled with each other. So, there is a limit to completely mixing different contents by using the above physical impact only.

Accordingly, it is necessary to develop a cosmetic container equipped with a discharge structure for mixing different contents to simultaneously discharge different types of contents to the outside while mixing the different types of contents more effectively.

### DOCUMENT OF RELATED ART

### (Patent Document)

Korean Patent Registration No. 10-1923306 (Published on Nov. 28, 2018), “HETEROGENEOUS MATERIAL MIXING VESSEL”

Korean Unexamined Patent Publication No. 10-2017-0012917 (Published on Feb. 6, 2017), “VESSEL HAVING MIXED TWO-TYPE MATERIALS”

### SUMMARY OF THE INVENTION

To solve the above problems, the present invention provides a cosmetic container with a discharge structure for mixing heterogeneous contents, in which heterogeneous contents in a discharge passage of a button are moved in zigzag while colliding with a plurality of mixing plates by a mixing shaft member, and rotated and moved to the center while being continuously collected by the mixing cap member, thereby changing the moving direction of the heterogeneous contents, so that the heterogeneous contents are mixed more efficiently and discharged to the outside.

In order to achieve the above-mentioned objects, one aspect of the present disclosure provides a cosmetic container with a discharge structure for mixing heterogeneous contents, which includes: a container body in which heterogeneous contents are stored; a discharging device for discharging the heterogeneous contents stored in the container body; and a button configured to operate the discharging device and formed with a discharge passage and a discharge port, wherein a mixing shaft member and a mixing cap member are provided in the discharge passage and the discharge port, so that the heterogeneous contents are mixed with each other.

In addition, the container body may include a first container body and a second container body to separately store the heterogeneous contents, the discharging device may include a first discharging device and a second discharging device to discharge the heterogeneous contents, respectively, and the button may be formed with a first connection passage and a second connection passage so as to be connected to the first discharging device and the second discharging device, respectively.

In addition, the discharge passage may installed therein with a mixing shaft member so that the heterogeneous contents are moved in zigzag, and the discharge port may be installed therein with a mixing cap member so that the heterogeneous contents are rotated and moved while being collected to the center.

In addition, the mixing shaft member and the mixing cap member may be consecutively arranged in a line along the discharge passage.

In addition, the mixing shaft member may include a central shaft and a plurality of mixing plates spaced apart from each other at a predetermined interval on the central shaft, in which the mixing plate has a plate shape formed at one side thereof with a moving passage, so that a moving direction of the heterogeneous contents is changed while colliding with the mixing plates.

In addition, a moving passage of one mixing plate and a moving passage of an adjacent mixing plate may be formed in opposite directions to each other.

In addition, the mixing shaft member may be formed at one end thereof with a distribution plate, in which the distribution plate may be disposed at a position adjacent to the mixing cap member and formed with a distribution passage.

In addition, the mixing plate of the mixing shaft member may have a disc shape with a rim that is partially straight.

In addition, the mixing cap member may be formed with a rotation moving groove, and the rotation moving groove may be formed at a center thereof with a rotation passage hole, so that the heterogeneous contents may pass through the rotation passage hole while being rotated along the rotation moving groove.

In addition, the rotation moving groove of the mixing cap member may be formed to be inclined at a predetermined angle around the rotation passage hole.

According to the embodiment of one aspect of the present disclosure, heterogeneous contents in a discharge passage of a button are moved in zigzag while colliding with a plurality of mixing plates by a mixing shaft member, and rotated and moved to the center while being collected by the mixing cap member, so that the heterogeneous contents can be mixed more efficiently and discharged to the outside through the above discharge structure for mixing heterogeneous contents.

According to the embodiment of one aspect of the present disclosure, the mixed discharge structure of heterogeneous contents may be formed just by inserting the mixing shaft member into the discharge passage of the button and inserting the mixing cap member into the discharge port, so that the discharge structure for mixing the heterogeneous contents can be simplified, and assembly can be easily and quickly performed, thereby increasing productivity.

### BRIEF DESCRIPTION OF THE DRAWINGS

FIG. 1 is a perspective view of a cosmetic container according to one embodiment of one aspect of the present disclosure.

FIG. 2 is an exploded perspective view of a cosmetic container according to one embodiment of one aspect of the present disclosure.

FIG. 3 is a sectional view of a cosmetic container according to one embodiment of one aspect of the present disclosure.

FIG. 4 is a sectional view illustrating a state in which heterogeneous contents are discharged while a button is pressed according to one embodiment of one aspect of the present disclosure.

FIG. 5 is a sectional view illustrating a state in which the button is recovered to the initial position according to one embodiment of one aspect of the present disclosure.

FIG. 6 is a partial perspective view showing a button on which a mixing shaft member and a mixing cap member of the cosmetic container according to one embodiment of one aspect of the present disclosure are formed.

FIG. 7 is a partial sectional view showing the button including the mixing shaft member and the mixing cap member of the cosmetic container according to one embodiment of one aspect of the present disclosure.

FIG. 8 is a partial perspective view illustrating a state in which cosmetics passes through the mixing shaft member according to one embodiment of one aspect of the present disclosure.

FIG. 9 is a partial perspective view illustrating a state in which the cosmetics passes through the mixing cap member according to one embodiment of one aspect of the present disclosure.

### DETAILED DESCRIPTION OF THE INVENTION

Hereinafter, the detailed descriptions of one aspect of the present disclosure are embodiments for carrying out one aspect of the present disclosure, and the corresponding embodiment refers to the accompanying drawings as an example. The embodiments will be described in detail to enable those skilled in the art to carry out one aspect of the present disclosure. It is apparent to be understood that the various embodiments of one aspect of the present disclosure may be different from each other but do not need to be mutually exclusive. For example, the particular shape, structure, and feature described herein may be embodied in other embodiments without departing from the idea and scope of one aspect of the present disclosure in connection with the embodiment. In addition, it shall be understood that the location or arrangement of an individual element within each disclosed embodiment may be modified without departing from the idea and scope of one aspect of the present disclosure.

Accordingly, the following detailed description does not disclose a limited meaning, and the scope of the invention is limited only by the appended claims, along with the full scope of equivalents to which the claims are entitled, if properly explained. Similar reference numerals in the drawings refer to the same or similar function throughout several aspects.

General term which is widely used recently has been selected in one aspect of the present disclosure in consideration of the function according to one aspect of the present disclosure as possible, however, the term may vary depending on the intention of those skilled in the art, judicial cases, the advent of new technology, or the like. Further, in certain cases, the term may be arbitrarily selected by the applicant, and in this case, the meaning thereof will be described in detail in the relevant description of the invention. Therefore, the term used in the present disclosure may be defined based on the meaning of the term and contents throughout the present disclosure, not simply on the name of the term.

When one part “includes” one element in one aspect of the present disclosure, the above expression does not exclude other elements but may further include the other elements, unless particularly stated otherwise.

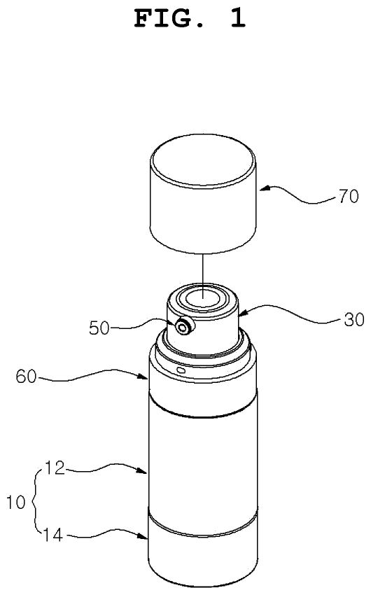

A cosmetic container with a discharge structure for mixing heterogeneous contents according to one embodiment of one aspect of the present disclosure will be described with reference to FIGS. 1 to 9.

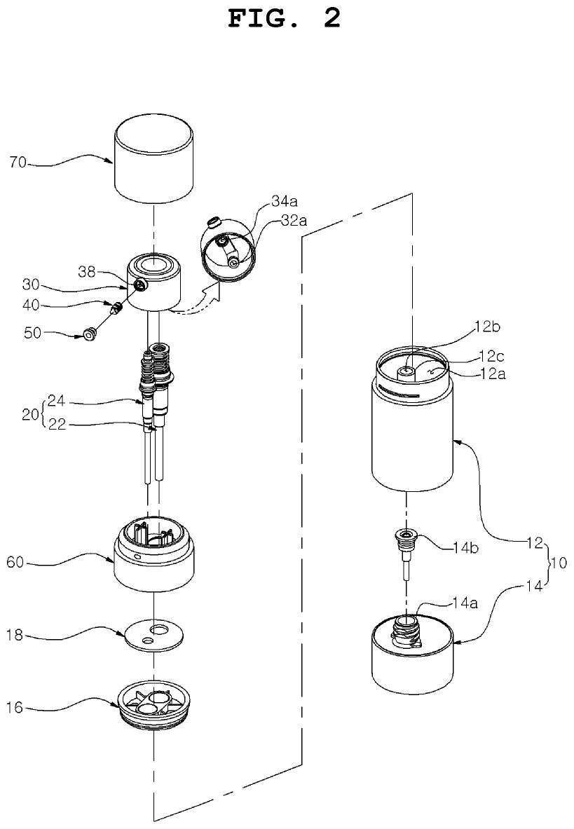

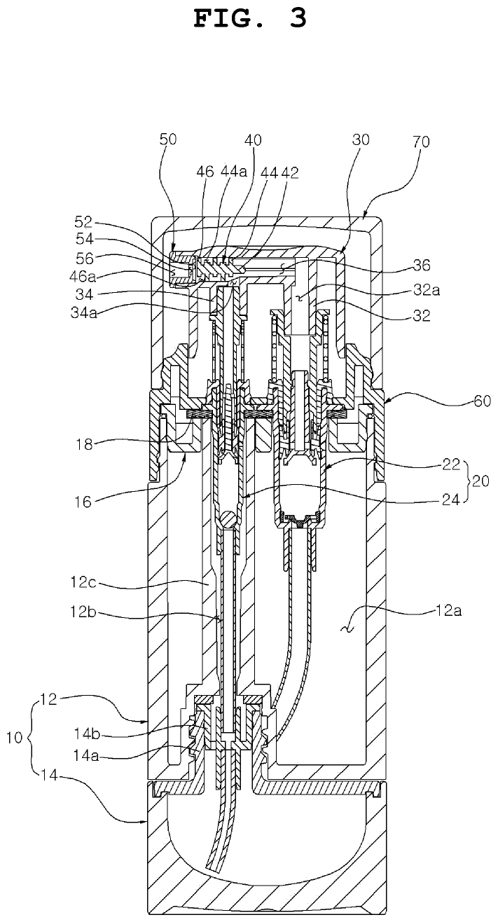

FIG. 1 is a perspective view of the cosmetic container according to one embodiment of one aspect of the present disclosure. FIG. 2 is an exploded perspective view of the cosmetic container according to one embodiment of one aspect of the present disclosure. FIG. 3 is a sectional view of the cosmetic container according to one embodiment of one aspect of the present disclosure.

As shown in the drawing, the cosmetic container with a discharge structure for mixing heterogeneous contents according to one embodiment of one aspect of the present disclosure may include a container body 10, a discharging device 20, and a button 30 provided with a mixing shaft member 40 and a mixing cap member 50.

Hereinafter, each component of the cosmetic container with the discharge structure for mixing heterogeneous contents according to one embodiment of one aspect of the present disclosure will be described.

The container body 10 stores heterogeneous contents therein, and is formed in a rigid cylindrical shape. The container body 10 is not limited to the rigid cylindrical shape, and may have various forms according to convenience in use, preference of a purchaser or fashion.

The container body 10 may include a first container body 12 and a second container body 14, so that the heterogeneous contents may be stored separately. The first container body 12 may be formed therein with a content storage space 12a for accommodating first contents c1, and may be formed with a container coupling space 12b to which the second container body 14 is coupled. As shown in FIG. 2, the container coupling space 12b may be formed to be biased in one direction from a center of the first container body 12, and may be separated from the content storage space 12a by a partition wall 12c. In addition, a screw thread may be formed in a lower portion of the container coupling space 12b and screwed with the second container body 14.

As shown in FIG. 3, a sealing cap 16 may be coupled to an opened upper portion of the first container body 12, a sealing plate 18 formed of an elastic material may be provided on an upper portion of the sealing cap 16, so that a sealing force of the first container body 12 may be maintained. In other words, the opened portion of the first container body 12 is closed by the sealing cap 16, and the sealing plate 18 is mounted on the upper portion of the sealing cap 16, so that the first contents c1 accommodated in the inner space of the first container body may be prevented from being leaked to the outside or external foreign substances may be prevented from being introduced into the inner space of the first container body 12.

Meanwhile, the sealing plate 18 is formed of a soft material, may be formed of at least one material of urethane rubber, natural rubber, elastomer, nitrile-butadiene rubber (NBR), and silicone, or at least one material of polypropylene, polyethylene, acrylonitrile butadiene styrene (ABS), and thermos-plastic elastomer (TPE) that are elastic. The sealing plate 18 is not limited to the above-described material, and may be formed of various materials within a range having a predetermined elasticity.

The second container body 14 is screwed to a lower portion of the first container body 12, and may be formed in a cylindrical shape corresponding to the first container body 12 for continuity of the container appearance.

In addition, second contents c2 may be stored inside the second container body 14. The second contents c2 are different from the first contents c1, and may be contents that double the efficacy or effectiveness when mixed and used with the first contents c1.

As shown in FIG. 2, an inlet portion 14a is formed on one side of the second container body 14, in which the second contents c2 are filled into the inlet portion 14a, a screw thread is formed on an outer circumference of the inlet portion 14a so as to be screwed with a screw thread formed on an inner wall of the container coupling space 12b of the first container body 12, and a connection portion 14b is inserted and fixed inside the inlet portion 14a. Like the container coupling space 12b of the first container body 12, the inlet portion 14a and the connection portion 14b may be biased in one direction from a center of the second container body 14.

Meanwhile, as shown in FIG. 3, a cap member 60 may be further coupled to the upper portion of the first container body 12. The cap member 60 may pressurize at least a part of the discharging device 20 to fix the discharging device 20 to the container body 10, and may allow the button 30 to be inserted into an opened upper portion to guide vertical movements of the button 30.

In addition, a container cover 70 may be detachably coupled to the upper portion of the cap member 60. The container cover 70 may be coupled to the cap member 60 while surrounding the button 30, so that the button 30 may be protected when carried or stored.

Although the drawing of the cosmetic container with a discharge structure for mixing heterogeneous contents according to one embodiment of one aspect of the present disclosure illustrates the first container body 12 and the cap member 60 in an undercut coupling scheme, one aspect of the present disclosure is not limited thereto, and various coupling schemes such as screw coupling, protrusion-groove coupling, or forced fitting coupling may be implemented.

The discharging device 20 discharges the heterogeneous contents accommodated in the container body 10 to the outside, and may include a first discharging device 22 and a second discharging device 24.

The first discharging device 22 has at least a part installed on the cap member 60 while being inserted into the content storage space 12a of the first container body 12, and discharges the first contents c1 stored in the first container body 12 to the outside.

The second discharging device 24 is installed on the cap member 60 while passing through the container coupling space 12b of the first container body 12, and has a lower portion inserted into the second container body 14, so that the second contents c2 stored in the second container body 14 are discharged to the outside.

The first discharging device 22 and the second discharging device 24 may be pumps for discharging a fixed amount of contents to the outside by a pumping action.

Meanwhile, a main portion of the second discharge device 24 is installed in the container coupling space 12b of the first container body 12 by the cap member 60, and a remaining portion of the second discharge device 24 is installed inside the second container body 14 through the connection portion 14b, so that all configurations of the second discharge device 24 are automatically connected by the connection portion 14b when the first container body 12 is coupled to the second container body 14.

In addition, the first discharging device 22 and the second discharging device 24 may have sizes and structures different from each other according to the using ratio of the first and second contents c1 and c2 to be pumped, respectively. For example, when the first contents c1 discharged by the first discharging device 22 are required to be discharged more than the second contents c2 discharged by the second discharging device 24 and mixed and used, a piston stroke distance and a cylinder inner diameter of the first discharging device 22 may be greater than those of the second discharging device 24.

The button 30 operates the discharging device 20, particularly, the first discharging device 22 and the second discharging device 24 of the discharging device 20 are simultaneously pressed and operated by the user's pressing manipulation.

As shown in FIG. 3, a lower portion of the button 30 is inserted into the opened upper portion of the cap member 60, and linearly moved in the operating direction of the first and second discharging devices 22 and 24. In addition, a first coupling portion 32 and a second coupling portion 34 are formed inside an outer wall of the button 30 so as to be coupled to the first and second discharging devices 22 and 24, and a first connection passage 32a and a second connection passage 34a are formed inside the first coupling portion 32 and the second coupling portion 34 so as to be connected to the first and second discharging devices 22 and 24, respectively.

A discharge passage 36 connected to the first and second connection passages 32a and 34a is formed inside the button 30, and a discharge port 38 is formed at an end of the discharge passage 36, in which the discharge passage 36 serves as a passage through which the first and second contents c1 and c2 pumped by the first and second discharging devices 22 and 24 are moved, and the discharge port 38 serves as an outlet through which the first and second contents c1 and c2 moved from the discharge passage 36 are discharged to the outside.

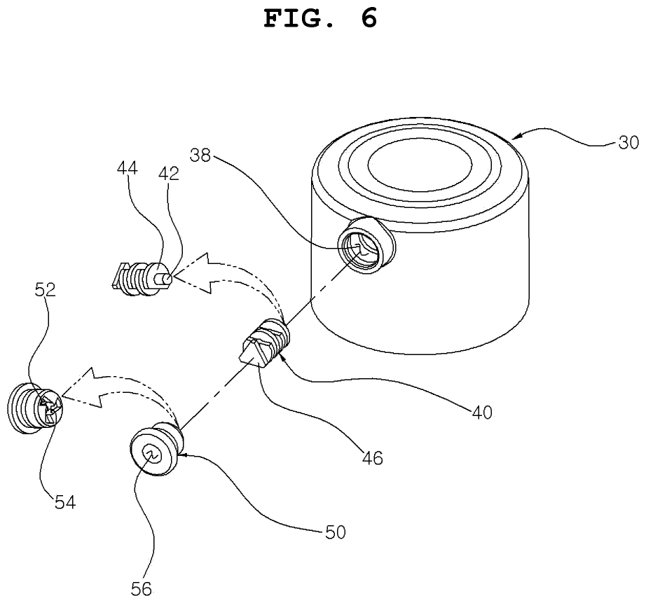

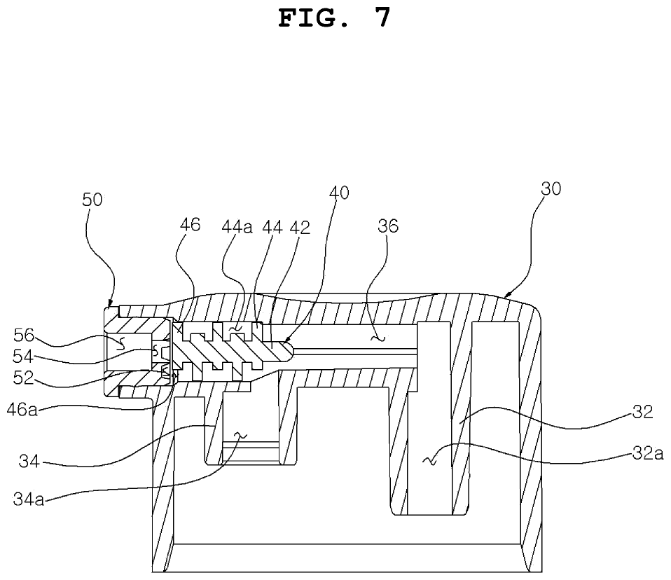

FIGS. 6 to 7 are a partial view separately illustrating the button of the cosmetic container according to one embodiment of one aspect of the present disclosure. The discharge structure for mixing the heterogeneous contents will be described in detail with reference to the above drawings.

FIG. 6 is a partial perspective view showing a button on which a mixing shaft member and a mixing cap member of the cosmetic container according to one embodiment of one aspect of the present disclosure are formed. FIG. 7 is a partial sectional view showing the button including the mixing shaft member and the mixing cap member of the cosmetic container according to one embodiment of one aspect of the present disclosure.

As shown in FIG. 6, a mixing shaft member 40 and a mixing cap member 50 are provided in the discharge passage 36 and the discharge port 38 of the button 30, so that the heterogeneous contents passing through the discharge passage 36 and the discharge port 38 are discharged while being mixed. In other words, the mixing shaft member 40 is installed inside the discharge passage 36, so that the heterogeneous contents are moved in zigzag, that is, change moving directions up and down alternately. Continuously, the mixing cap member 50 is installed inside the discharge port 38, so that the heterogeneous contents may be rotated and moved while being collected toward a center of the discharge passage 36.

In other words, in the related art, since different types of contents are merely discharged to the outside through a discharge port at the same time, and the different contents are incompletely mixed, the efficacy or effect cannot be properly utilized, or since the different contents simply are entangled together while hitting a predetermined obstacle repeatedly, there is a limit to completely mixing the different contents. Accordingly, in the cosmetic container with a discharge structure for mixing heterogeneous contents according to one embodiment of one aspect of the present disclosure, the mixing shaft member 40 and the mixing cap member 50 are consecutively disposed inside the button 30, and movements of the heterogeneous contents are shifted from linear movements to zigzag and rotational movements by the linkage action between the mixing shaft member 40 and the mixing cap member 50, so that the heterogeneous contents may be mixed more effectively and discharged together to the outside. In addition, in the cosmetic container with a discharge structure for mixing heterogeneous contents according to one embodiment of one aspect of the present disclosure, the discharge structure for mixing the heterogeneous contents may be formed just by inserting the mixing shaft member 40 into the discharge passage 36 of the button 30 and inserting the mixing cap member 50 into the discharge port 38, so that the discharge structure for mixing the heterogeneous contents is simplified, and assembly is easily and quickly performed, thereby increasing productivity.

As shown in FIG. 7, the mixing shaft member 40 may include a central shaft 42 and a plurality of mixing plates 44 spaced apart from each other at a predetermined interval on the central shaft 42. The central shaft 42 serves as a shaft for arranging the mixing plates 44 in a line, and the mixing plate 44 has a plate shape formed at one side thereof with a moving passage 44a. A moving passage 44a of one mixing plate 44 and a moving passage 44a of an adjacent mixing plate 44 may be formed in opposite directions to each other.

More specifically, the first and second contents c1, c2 pumped by the discharging device 20 pass through a mixing shaft member 40 having a plurality of mixing plates 44 while being moved along the discharge passage 36 through the first and second connection passages 32a and 34a. The first and second contents c1 and c2 collide with one surface of the mixing plate 44 and pass through the moving passage 44a formed on one side of the mixing plate 44. As described above, while repeating the process of passing through the mixing plate 44, the first and second contents c1 and c2 are not moved in a straight line along the discharge passage 36, but alternately moved above and below the mixing plates 44, so that the first and second contents c1 and c2 are mixed with each other.

The mixing plate 44 of the mixing shaft member 40 is formed in a shape corresponding to a cross section of the discharge passage 36. In particular, a major portion of a rim of the mixing plate 44 may have a curved surface in close contact with the inner wall of the discharge passage 36, and a remaining portion may be formed in a straight line spaced apart from the inner wall of the discharge passage 36.

Meanwhile, a distribution plate 46 is formed at one end of the mixing shaft member 40 while being spaced apart from the mixing plate 44 at a predetermined distance, in which the distribution plate 46 may be disposed at a position adjacent to the mixing cap member 50, and at least two distribution passages 46a spaced apart from the inner wall of the discharge passage 36 may be formed in the rim portion. The distribution plate 46 enables the heterogeneous contents having passed through the mixing plate 44 to be dispersed in several branches through the distribution passage 46a so as to be moved to an outer portion of the mixing cap member 50. In other words, the heterogeneous contents having passed through the mixing plate 44 of the mixing shaft member 40 collide with one surface of the distribution plate 46 and are moved while spreading to an outer side of the distribution plate 46, and the heterogeneous contents moved in the above manner pass through each distribution passage 46a formed in the rim of the distribution plate 46, and are moved toward a rim of the mixing cap member 50.

Although the drawing of the cosmetic container with a discharge structure for mixing heterogeneous contents according to one embodiment of one aspect of the present disclosure illustrates the distribution plate 46 has a triangular plate shape having three distribution passages 46a, one aspect of the present disclosure is not limited thereto, and may be variously changed in consideration of the number and the size of the distribution passages 46a.

The mixing cap member 50 is coupled while being fitted to the discharge port 38 of the button 30, so that the heterogeneous contents having passed through the mixing shaft member 40 are rotated and moved.

As shown in FIG. 6, at least two or more rotational moving grooves 52 are formed in the mixing cap member 50, and a rotation passage hole 54 is formed at a center of the rotation moving groove 52, so that the heterogeneous contents passes through the rotation passage hole 54 while being rotated along the rotation moving groove 52. In addition, at least a part of the mixing cap member 50 is inserted into the discharge port 38 of the button 30, and a discharge hole 56 connected to the discharge passage 36 is formed in the center of the mixing cap member 50.

At least one rotation moving groove 52 is formed in a position adjacent to the distribution plate 46 of the mixing shaft member 40, and guides the heterogeneous contents having passed through the distribution plate 46 to rotate while being collected in the center. To this end, the rotation moving groove 52 extends outward from the center on one end surface of the mixing cap member 50, and may be formed to be inclined at a predetermined angle around the rotation passage hole.

In other words, the heterogeneous contents dispersed in several branches through the distribution passage 46a of the distribution plate 46 are moved to one side of the mixing cap member 50. The dispersed heterogeneous contents are introduced into each rotation moving groove 52 and collected to the center while being rotated and moved along the rotation moving groove 52, and sequentially pass through the rotational passage hole 54 and the discharge hole 56 of the rotation cap member 50. Through the dispersing and rotating process of the heterogeneous contents, the heterogeneous contents are entangled with each other and completely mixed.

The rotation moving groove 52 may be formed to correspond to the number or position of the distribution passages 46a of the distribution plate 46. For example, as shown in the drawings, when three distribution passages 46a of the distribution plate 46 are formed, the number of the rotation moving groove 52 is also three at one end of the mixing cap member 50. When the distribution passages 46a of the distribution plate 46 are spaced apart at intervals of 120 degrees, the rotation moving groove 52 may also be disposed at 120 degree intervals at one end of the mixing cap member 50.

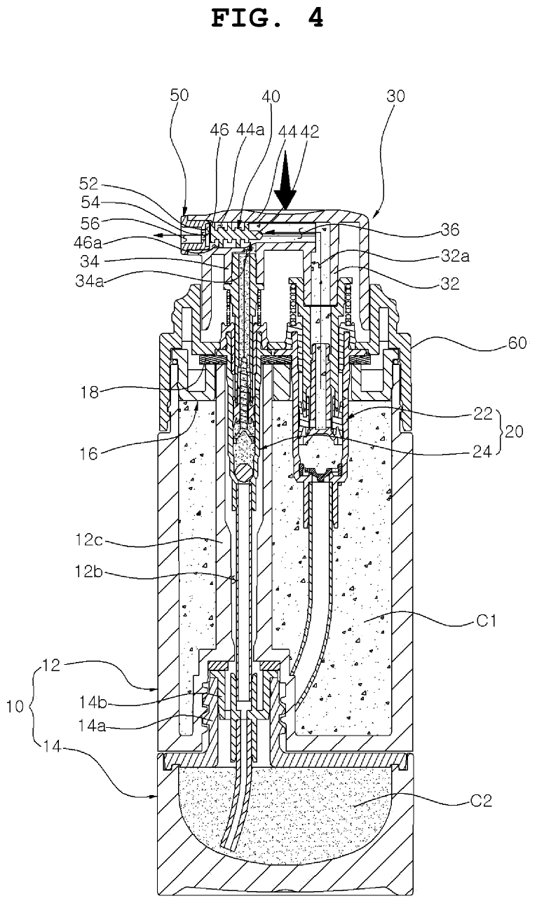

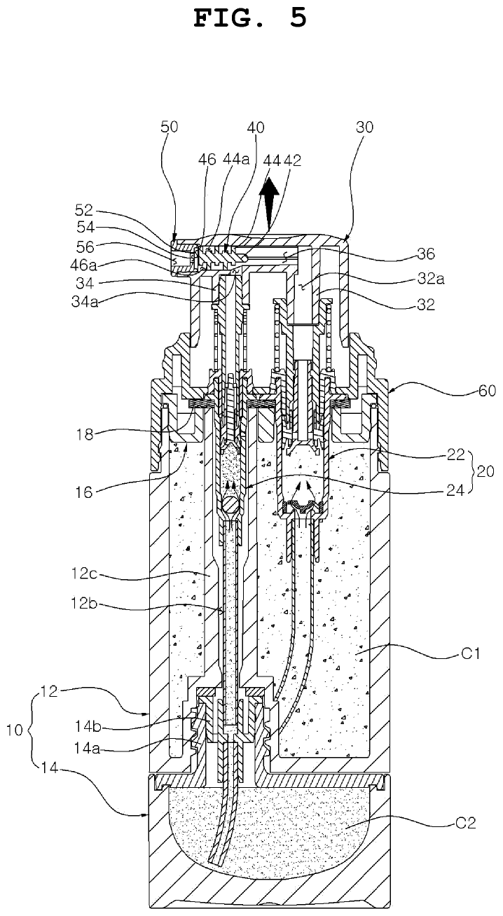

FIGS. 4 to 5 are views illustrating the use of the cosmetic container with a discharge structure for mixing heterogeneous contents according to one embodiment of one aspect of the present disclosure. The use process of the cosmetic container with a discharge structure for mixing heterogeneous contents according to one embodiment of one aspect of the present disclosure will be described with reference to the above drawings.

FIG. 4 is a sectional view illustrating a state in which heterogeneous contents are discharged while a button is pressed according to one embodiment of one aspect of the present disclosure. FIG. 5 is a sectional view illustrating a state in which the button is recovered to the initial position according to one embodiment of one aspect of the present disclosure.

As shown in FIG. 4, when the button 30 coupled to the upper portion of the container body 10 is pressed, the first discharging device 22 and the second discharging device 24 are simultaneously pressed by the button 30, so that the first contents c1 and the second contents c2 accommodated in the first container body 12 and the second container body 14 are discharged to the outside through the discharge port 38 of the button 30.

Thereafter, as shown in FIG. 5, when the press of the button 30 is released the button is elastically restored to the initial position by the first discharging device 22 and the second discharging device 24, and the first contents c1 and the second contents c2 accommodated in the first container body 12 and the second container body 14 are introduced into the first discharging device 22 and the second discharging device 24.

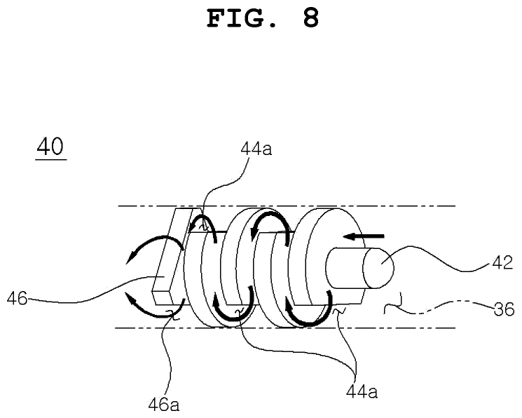

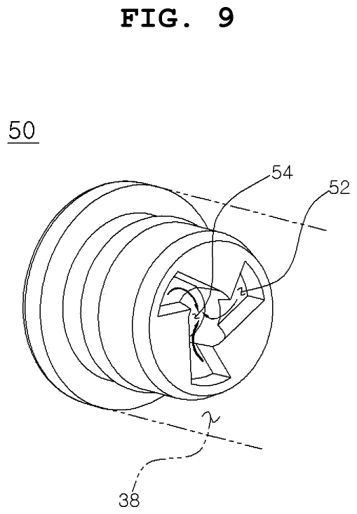

Meanwhile, hereinafter, the mixing and discharging process of the first contents c1 and the second contents c2 will be described in detail with reference to FIGS. 8 and 9.

FIG. 8 is a partial perspective view illustrating a state in which cosmetics passes through the mixing shaft member according to one embodiment of one aspect of the present disclosure. FIG. 9 is a partial perspective view illustrating a state in which the cosmetics passes through the mixing cap member according to one embodiment of one aspect of the present disclosure.

First, the first and second contents c1 and c2 pumped by the first and second discharging devices 22 and 24 pass through the mixing shaft member 40 having a plurality of mixing plates 44 while being moved along the discharge passage 36 through the first and second connection passages 32a and 34a. As shown in FIG. 8, the first and second contents c1 and c2 hit one surface of the mixing plate 44, and pass through the moving passage 44a formed on one side of the mixing plate 44. While the process of passing through the mixing plate 44 is repeated as in the above manner, the first and second contents c1 and c2 are mixed with each other while alternately crossing above and below the mixing plate 44.

Then, the heterogeneous contents having passed through the mixing plate 44 of the mixing shaft member 40 collide with one surface of the distribution plate 46 and are moved while spreading to an outer side of the distribution plate 46, and the heterogeneous contents moved in the above way pass through each distribution passage 46a formed in the rim of the distribution plate 46 and are moved toward a rim of the mixing cap member 50.

Then, the heterogeneous contents dispersed in several branches through the distribution passage 46a of the distribution plate 46 are moved to one side of the mixing cap member 50. The distributed heterogeneous contents are introduced into each rotation moving groove 52, and collected to the center while being rotated and moved along the rotation moving groove 52 as shown in FIG. 9, and sequentially pass through the rotational passage hole 54 and the discharge hole 56 of the rotation cap member 50 so as to be discharged to the outside. Through the dispersing and rotating process of the heterogeneous contents, the heterogeneous contents are entangled with each other and completely mixed.

Although one aspect of the present disclosure has been described with the particulars such as specific elements, limited embodiments, and drawings, the above description is provided only to help comprehensive understanding of one aspect of the present disclosure, and one aspect of the present disclosure is not limited to the embodiments. It is obvious to a person having ordinary skill in the art that various changes and modifications may be available.

Therefore, the spirit of one aspect of the present disclosure may not be limited to the aforementioned embodiments, and the following claims as well as all modifications or variations belonging to the equivalents of the claims will be within the scope of the invention.

What is claimed is:

1. A cosmetic container with a discharge structure for mixing heterogeneous contents, the cosmetic container comprising:
a container body in which heterogeneous contents are stored;
a discharging device for discharging the heterogeneous contents stored in the container body; and
a button configured to actuate the discharging device and formed with a discharge passage and a discharge port, wherein
a mixing shaft member and a mixing cap member are formed in the discharge passage and the discharge port, so that the heterogeneous contents are mixed with each other.

2. The cosmetic container of claim 1, wherein the container body includes a first container body and a second container body to separately store the heterogeneous contents, the discharging device includes a first discharging device and a second discharging device to discharge the heterogeneous contents, respectively, and the button is formed with a first connection passage and a second connection passage so as to be connected to the first discharging device and the second discharging device, respectively.

3. The cosmetic container of claim 1, wherein the discharge passage is installed therein with a mixing shaft member, so that the heterogeneous contents are moved in zigzag, and the discharge port is installed therein with a mixing cap member, so that the heterogeneous contents are rotated and moved while being collected in the center.

4. The cosmetic container of claim 1, wherein the mixing shaft member and the mixing cap member are consecutively arranged in a line along the discharge passage.

5. The cosmetic container of claim 1, wherein the mixing shaft member includes a central shaft and a plurality of mixing plates spaced apart from each other at a predetermined interval on the central shaft, in which the mixing plate has a plate shape formed at one side thereof with a moving passage, so that a moving direction the heterogeneous contents is changed as the heterogeneous contents collide with the mixing plates.

6. The cosmetic container of claim 5, wherein a moving passage of another mixing plate, which is adjacent to the mixing plate, is opposite to the moving passage of the mixing plate.

7. The cosmetic container of claim 5, wherein the mixing shaft member is formed at one end thereof with a distribution plate, in which the distribution plate is disposed at a position adjacent to the mixing cap member and formed with a distribution passage.

8. The cosmetic container of claim 5, wherein the mixing plate of the mixing shaft member has a disc shape with a rim that is partially straight.

9. The cosmetic container of claim 1, wherein the mixing cap member is formed with a rotation moving groove, and the rotation moving groove is formed at a center thereof with a rotation passage hole, so that the heterogeneous contents passes through the rotation passage hole while being rotated along the rotation moving groove.

10. The cosmetic container of claim 9, wherein the rotation moving groove of the mixing cap member is formed to be inclined at a predetermined angle around the rotation passage hole.
